(19) United States
(12) Patent Application Publication
(10) Pub. No.: US 2018/0333934 A1
(43) Pub. Date: Nov. 22, 2018

(54) POST-VULCANIZATION BONDING

(71) Applicant: LORD Corporation, Cary, NC (US)

(72) Inventor: John E. HILL, Apex, NC (US)

(21) Appl. No.: 15/846,892

(22) Filed: Dec. 19, 2017

Related U.S. Application Data
(62) Division of application No. 13/950,964, filed on Jul. 25, 2013, now abandoned.
(60) Provisional application No. 61/675,370, filed on Jul. 25, 2012.

(51) Int. Cl. B32B 7/12; C09J 163/00; C09J 123/34; C09J 5/00; C09J 4/06; B32B 37/12; C09D 123/34

(52) U.S. Cl. CPC B32B 7/12; C09J 163/00; C09J 123/34; C09J 5/00; Y10T 428/2804; B32B 37/1284; C09D 123/34; Y10T 428/2843; C09J 4/06

(57) ABSTRACT

A two part adhesive system is provided with the first part being a substrate-adhesive containing at least one of a urethane, an acrylic, or an epoxy based adhesive and the second part being an elastomer-primer comprising a halogenated polyolefin and, optionally a nitroso compound. Further provided is a method of post-vulcanization bonding of an elastomer to a substrate employing the adhesive outlined above.

### CROSS-REFERENCE TO RELATED APPLICATIONS

The present application is a divisional application of U.S. Ser. No. 13/950,964, filed Jul. 25, 2013 which claims priority under 35 U.S.C. § 119(e) from U.S. Provisional Patent Application Ser. No. 61/675,370 filed Jul. 25, 2012, entitled “IMPROVED POST-VULCANIZATION BONDING”, the disclosure of which is incorporated herein by reference.

### FIELD OF THE INVENTION

The present invention relates to a two part post vulcanization adhesive system and a method for post vulcanization bonding of an elastomeric substrate.

### BACKGROUND OF THE INVENTION

There has long existed a need for a robust adhesive and method for bonding vulcanized rubber or other cured elastomers to metal and other substrates. In most rubber bonding processes, a traditional rubber-to-substrate adhesive, such as CHEMLOK® adhesive sold by LORD Corporation, is applied to a metal part, which is then loaded into a mold and unvulcanized rubber or other elastomer is injected into the mold. The rubber filled mold is then heated to co-cure the adhesive during vulcanization of the rubber. This ensures a robust bond between the rubber and metal substrates.

There are, however, applications where co-curing an adhesive with the rubber is impractical or impossible. For example, during the manufacture of parts such as certain mounts and bushings, bonding must take place after the rubber part has been formed and vulcanized. In some circumstances, post-vulcanization rubber-to-substrate bonding can also provide significant cost advantages compared to in-mold bonding. In these instances, it is necessary to form a bond between the vulcanized rubber and a rigid substrate such as metal.

Prior art solutions generally employ an epoxy based metal-bonding adhesive to provide adhesion to the metal side, and the rubber surface is chemically treated to enhance the adhesion between the rubber and the epoxy metal-bonding adhesive. These methods, while sometimes effective, often do not provide as good a bond as is desired, and in particular, the ability of these systems to remain bonded under high temperature is often poor.

It is therefore desirable to provide materials and a method for post-vulcanization bonding of elastomers, such as natural rubber, to non-elastomeric substrates, such as steel and engineered polymers.

It is to these perceived needs that the present invention is directed.

### SUMMARY OF THE INVENTION

In a first aspect of the present invention, a two part adhesive system is provided comprising (a) a substrate-adhesive comprising at least one of a urethane, an acrylic, or an epoxy based adhesive and, (b) an elastomer-primer comprising a halogenated polyolefin and, optionally a nitroso compound. In one embodiment of the invention, the halogenated polyolefin comprises brominated poly(dichlorobutadiene). In another embodiment of the invention, the halogenated polyolefin comprises chlorinated natural rubber. In a further embodiment of the present invention, the halogenated polyolefin comprises chlorosulfonated polyethylene. In another embodiment of the present invention, the nitroso compound comprises poly-dinitrosobenzene.

In a further aspect of the invention, the substrate adhesive comprises a urethane based adhesive and further includes a catalyst. In a still further aspect of the present invention, the substrate adhesive comprises an epoxy based adhesive and further comprises an amine hardener. In yet another aspect of the invention, wherein the substrate adhesive comprises an acrylic based adhesive further comprising redox initiator system.

In another embodiment of the present invention, the substrate-adhesive is essentially free, or free, of phenolic resins, other than phenolic epoxy materials. In a further embodiment of the present invention, the substrate-adhesive is essentially free, or free, of halogenated polyolefins. In yet another embodiment of the invention, the elastomer-primer is essentially free, or free, of epoxy resins, other than phenolic epoxy materials. In yet another embodiment of the invention, the elastomer-primer is essentially free, or free, of phenolic resins. A further embodiment of the invention comprises a two-part adhesive system wherein the elastomer-primer comprises a bismaleimide material. In a still further embodiment of the present invention, the elastomer-primer comprises a solvent-based primer. In an alternate embodiment of the present invention, the elastomer-primer comprises an aqueous primer.

In another aspect of the invention, the elastomer-primer has been applied to a vulcanized elastomeric part and the substrate-adhesive has been applied to a metal part. In a further aspect of the invention, the elastomeric part and metal part have been brought into contact such that the elastomer-primer and the substrate adhesive are in contact with one another to form a bonded assembly. In a still further embodiment of the invention, the bonded assembly exhibits at least 90% rubber retention when pulled at a temperature of above 100° C. at an angle of 90° in accordance with ASTM D 429.

In another aspect of the present invention, a method for post vulcanization bonding of an elastomer is provided comprising (a) providing a vulcanized elastomer, (b) applying an elastomer-primer composition to the vulcanized elastomer wherein the elastomer-primer composition comprises a halogenated polyolefin and dinitrosobenezene, (c) providing a substrate to be bonded, (d) applying a substrate-adhesive to the substrate wherein the substrate-adhesive comprises at least one of an epoxy, acrylic, or urethane based adhesive, and (e) bringing the elastomer-primer coated vulcanized elastomer into contact with the substrate-adhesive coated substrate such that at least a portion of the epoxy adhesive contact at least a portion of the halogenated polyolefin primer to form an assembly.

In another embodiment of the invention the method further comprises the step of (f) heating the assembly to cure the elastomer-primer. In a further embodiment of the invention, the assembly is heated to at least 250° F. for at about 5 minutes. In another embodiment of the invention, the elastomer-primer is applied to the elastomer without a pre-treatment step.

Thus, there has been outlined, rather broadly, the more important features of the invention in order that the detailed description that follows may be better understood and in order that the present contribution to the art may be better appreciated. There are, obviously, additional features of the invention that will be described hereinafter and which will form the subject matter of the claims appended hereto. In this respect, before explaining several embodiments of the invention in detail, it is to be understood that the invention is not limited in its application to the details and construction and to the arrangement of the components set forth in the following description. The invention is capable of other embodiments and of being practiced and carried out in various ways.

It is also to be understood that the phraseology and terminology herein are for the purposes of description and should not be regarded as limiting in any respect. Those skilled in the art will appreciate the concepts upon which this disclosure is based and that it may readily be utilized as the basis for designating other structures, methods and systems for carrying out the several purposes of this development. It is important that the claims be regarded as including such equivalent constructions insofar as they do not depart from the spirit and scope of the present invention.

### DETAILED DESCRIPTION OF THE PREFERRED EMBODIMENTS

In a first aspect of the present invention, a two part adhesive system is provided comprising a substrate-adhesive and an elastomer-primer. The substrate-adhesive preferably comprises an epoxy, acrylic, or urethane based adhesive that has an affinity for bonding substrates such as metals or engineered polymers. The elastomer-primer preferably comprises a primer that has an affinity for bonding the elastomer. Use of this two-part adhesive system provides surprisingly robust bonding of post-vulcanized rubber and other elastomers to metal and other rigid substrates. In particular, the high temperature performance of such adhesive systems is greatly improved over prior art solutions.

The substrate-adhesive preferably comprises an epoxy, acrylic, or urethane based adhesive. Examples of such epoxy adhesives include the FUSOR® line of epoxy adhesives, sold by LORD Corporation. Examples of such urethane and acrylic adhesives comprise the LORD® line of adhesives, sold by LORD Corporation.

In a preferred embodiment of the present invention, the substrate-adhesive comprises a high Tg to provide better adhesion at higher temperatures. In one embodiment of the present invention, the Tg of the metal-bonding adhesive is at least 70° C., more preferably at least 95° C. and most preferably above 110° C. It is speculated that a high Tg is preferable because, at sufficiently high temperatures, failure occurs when the substrate adhesive loses adhesion to the rubber-bonding primer. Selecting a material with a higher Tg in the metal-bonding adhesive part increases the operating temperature of the final adhesive bond.

In a preferred embodiment of the present invention, the elastomer-primer comprises a halogenated polyolefin-based adhesive, preferably containing a nitroso compound. Examples of commercial products with related chemistries to these elastomer-primers include many of the CHEMLOK® line of adhesives sold by LORD Corporation. Such elastomer primers may be delivered in a solvent, aqueous, or powder form as is known in the art.

### Epoxy

In a preferred embodiment of the present invention, the substrate-adhesive comprises an epoxy-based adhesive. The epoxy compound of the present invention can be any material that contains an epoxy (oxirane) group. Included epoxy resins are epoxy cresol novolacs, epoxy phenol novolacs, and blends of either of these with bisphenol A epoxy resins. Monomeric epoxy compounds and epoxides of the polymeric type and can be aliphatic, cycloaliphatic, aromatic or heterocyclic. The “average” number of epoxy groups per molecule is determined by dividing the total number of epoxy groups in the epoxy-containing material by the total number of epoxy molecules present. Useful epoxy materials generally contain on the average at least 1.5 polymerizable epoxy groups per molecule. Preferably two or more epoxy groups per molecule are present. The polymeric epoxides include linear polymers having terminal epoxy groups (e.g., a diglycidyl ether of a polyoxyalkylene glycol), polymers having skeletal oxirane units (e.g., polybutadiene polyepoxide), and polymers having pendent epoxy groups (e.g., a glycidyl methacrylate polymer or copolymer). The epoxides may be pure compounds but are generally mixtures containing one, two, or more epoxy groups per molecule.

The epoxy-containing materials may vary from low molecular weight monomeric materials to high molecular weight polymers, and may vary greatly in the nature of their backbone and substituents groups. For example, the backbone may be of any type and substituent groups thereon being free of an active hydrogen atom. Illustrative of permissible substituent groups include halogens, ester groups, ethers, sulfonate groups, siloxane groups, nitro groups, phosphate groups, etc. The molecular weight of the epoxy-containing materials may vary from about 50 to 100,000 or more. Mixtures of various epoxy-containing materials can also be used in the compositions of this invention.

The epoxy compounds of the present invention can be cycloaliphatic epoxides. Examples of cycloaliphatic epoxides include diepoxides of cycloaliphatic esters of dicarboxylic acids such as bis(3,4-epoxycyclohexylmethyl)oxalate, bis(3,4-epoxycyclohexylmethyl)adipate, bis(3,4-epoxy-6-methylcyclohexylmethyl)adipate, bis(3,4-epoxycyclohexylmethyl)pimelate, and the like. Other suitable diepoxides of cycloaliphatic esters of dicarboxylic acids are described in, for example, U.S. Pat. No. 2,750,395, which is incorporated herein by reference.

Epoxy resins based on bisphenol A, either solids and capable of dissolution in a carrier, or liquids, are preferred as these are relatively inexpensive. There are a myriad of available epoxy materials, collectively referred to as epoxy resins, whether resinous or simple compounds. In particular, simple epoxy compounds that are readily available include octadecylene oxide, glycidylmethacrylate, diglycidyl ether of bisphenol A (e.g., those available under the trade designations EPON from Shell Chemical Co., DER, from Dow Chemical Co.), vinylcyclohexene dioxide (e.g., ERL-4206 from Union Carbide Corp.), 3,4-epoxycyclohexylmethyl-3,4-epoxycyclohexane carboxylate (e.g., ERL-4221 from Union Carbide Corp.), 3,4-epoxy-6-methylcyclohexylmethyl-3,4-epoxy-6-methylcyclohexene carboxylate (e.g., ERL-4201 from Union Carbide Corp.), bis(3,4-epoxy-6-methylcyclohexylmethyl) adipate (e.g. ERL-4289 from Union Carbide Corp.), bis(2,3-epoxycyclopentyl) ether (e.g., ERL-0400 from Union Carbide Corp.), aliphatic epoxy modified with polypropylene glycol (e.g., ERL-4050 and ERL-4052 from Union Carbide Corp.), dipentene dioxide (e.g., ERL-4269 from Union Carbide Corp.), epoxidized polybutadiene (e.g., OXIRON 2001 from FMC Corp.), silicone resin containing epoxy functionality, flame retardant epoxy resins (e.g., DER-580, a brominated bisphenol type epoxy resin available from Dow Chemical Co.), 1,4-butanediol diglycidyl ether of phenolformaldehyde novolak (e.g., DEN-431 and DEN-438 from Dow Chemical Co.), and resorcinol diglycidyl ether.

In a further embodiment of the present invention, the epoxy-based adhesive comprises an amine hardener comprising an amine-type curing agent for epoxy resins. For example, aliphatic polyamines, cycloaliphatic polyamines, tertiary amines, polyaminoamides, and various mixtures thereof are used for this purpose. Examples of amine hardeners for purposes of the present invention include diethylenetriamine, triethylenetetramine, tetraethylenepentamine, 2-methyl-1,5-pentanediamine, diethanolamine, methyl di ethanol amine, triethanolamine, pentaethylenehexamine, ethylenediamine, tetramethylenediamine, hexamethylenediamine, polyetherdiamine, bis-hexamethylenetriamine, diethylaminopropylamine, trimethylhexa-methylenediamine, oleylamine, dipropylenetriamine, 1,3,6-tris-aminomethylhexane, 3,9-bis(3-aminopropyl)-2,4,8,10-tetraoxaspiro[5,5]-undecane, 1,3-bis-aminomethyl cyclohexane, bis(4-aminocyclohexyl)-methane, bis(4-amino-3-methylcyclohexyl)methane, isophoronediamine, N-aminoethylpiperazine, and the like. Aliphatic polyamines which are modified by adduction with epoxy resins or acrylonitrile, or by condensation with fatty acids can also be utilized as amine hardeners. In addition, various Mannich bases can be employed as amine hardeners for purposes of the present invention.

Aromatic polyamines wherein the amine groups are directly attached to the aromatic ring, such as xylene diamine and the like, can also be used in the practice of the invention but are less preferred to the aliphatic diamines. Examples of aromatic polyamines include diaminophenylmethane, aniline-formaldehyde low molecular weight condensate, m-phenylenediamine, diaminodiphenyl-sulfone, and the like.

Unhindered aliphatic amine hardener herein refers to an amine compound containing a primary amine group attached to a primary carbon atom. The amine hardener may optionally be utilized in an amount ranging from about 10 to 50, preferably from about 20 to 40, percent by weight of the essential ingredients of the substrate-adhesive composition.

In a further embodiment of the present invention employing an amine-cured epoxy as the substrate-adhesive, the EEW/AHEW ratio (Epoxy Equivalent Weight to Amine Hydrogen Equivalent Weight), comprises 0.5-1.5, and preferably 0.8-1.2.

### Acrylic

In a further embodiment of the present invention, the substrate adhesive comprises an acrylic-based adhesive. Preferred free radical-polymerizable monomers in accordance with an embodiment of the present invention comprise olefinic monomers that are characterized by the presence of a —C═C— group. Representative olefinic monomers include esters of (meth)acrylic acid such as methyl methacrylate, ethyl methacrylate, butyl methacrylate, methyl acrylate, butyl acrylate, cyclohexyl acrylate, hexyl acrylate, 2-ethylhexyl acrylate, lauryl acrylate, ethyl acrylate, diethylene glycol dimethacrylate, dicyclopentadienyl oxyethyl methacrylate, cyclohexyl methacrylate, lauryl methacrylate, glycidyl methacrylate and tetrahydrofurfuryl methacrylate; methacrylic acid; acrylic acid; substituted (meth)acrylic acids such as itaconic acid, acrylonitrile, methacrylonitrile, acrylamide and methacrylamide; styrene; substituted styrenes such as vinyl styrene, chlorostyrene, methyl styrene and n-butyl styrene; vinyl acetate; vinylidene chloride; and butadienes such as 2,3-dichloro-1,3-butadiene and 2-chloro-1,3-butadiene. Other olefinic monomers include maleate esters; fumarate esters; and styrenic compounds such as styrene, chlorostyrene, methyl styrene, butyl styrene and vinyl styrene.

In one embodiment of the present invention, the monomer is present in the acrylic adhesive in an amount from 10-90 percent by weight of the principal components. In a further embodiment of the present invention, the monomer is present in an amount from 20-70 percent by weight of the principal components. In a still further embodiment of the present invention, the monomer is present in an amount from 30-60 percent by weight of the principal component.

In one embodiment, the acrylic adhesive contains an ambient temperature reactive redox initiator or catalyst system. The ambient temperature-reactive catalyst systems are well-known redox couple systems and need not be discussed herein in extensive detail, but they include at least one oxidizing agent and at least one reducing agent which are co-reactive at ambient temperature to generate free radicals effective to initiate addition polymerization reactions and cure the adhesive. Suitable redox (oxidation-reduction) initiators include, but are not limited to, combinations of persulfate initiators with reducing agents such as sodium metabisulfite and sodium bisulfite; systems based on organic peroxides and tertiary amines (for example, benzoyl peroxide plus dimethylaniline); and systems based on organic hydroperoxides and transition metals, for example, cumene hydroperoxide plus cobalt naphthenate.

In one embodiment of the present invention, substantially any of the known oxidizing agents may be employed. Representative oxidizing agents include, without limitation, organic peroxides, such as benzoyl peroxide and other diacyl peroxides, hydroperoxides such as cumene hydroperoxide, peresters such as β-butylperoxybenzoate; ketone hydroperoxides such as methyl ethyl ketone hydroperoxide, organic salts of transition metals such as cobalt naphthenate, and compounds containing a labile chlorine such as sulfonyl chloride. In an embodiment of the present invention wherein a nitroso compound is employed in the elastomer-primer, the substrate-adhesive is preferably free from peroxide compounds as nitroso compounds may interfere with the peroxide cure mechanism.

Representative reducing agents include, without limitation, sulfinic acids; azo compounds such as azoisobutyric acid dinitrile; alpha-aminosulfones such as bis(tolysulfonmethyl)-benzyl amine; tertiary amines such as diisopropanol-p-toluidine (DIIPT), dimethyl aniline, p-halogenated aniline derivatives and dimethyl-p-toluidine; and aminealdehyde condensation products, for example, the condensation products of aliphatic aldehydes such as butyraldehyde with primary amines such as aniline or butylamine. Preferred reducing agents are p-halogenated aniline derivatives. Exemplary reducing agents include, but are not limited to, N,N-diisopropanol-p-chloroaniline; N,N-diisopropanol-p-bromoaniline; N,N-diisopropanol-p-bromo-m-methylaniline; N,N-dimethyl-p-chloroaniline; N,N-dimethyl-p-bromoaniline; N,N-diethyl-p-chloroaniline; and N,N-diethyl-p-bromoaniline.

Preferably, the oxidizing agent will be present in an amount in the range from about 0.5 to about 50 percent by weight of polymerizable adhesive composition, with the amount of reducing agent being in the range from about 0.05 to about 10 preferably about 0.1 to about 6, percent by weight of polymerizable adhesive composition.

Optionally, a toughener polymer can be used at from about 0 to 80 percent, and more preferably 2-50 percent, by weight of the principal components of the acrylic adhesive. An exemplary low molecular weight toughener has a weight average molecular weight (Mw) of less than about 18,000 or a number average molecular weight (Mn) of less than about 10,000. The toughener polymer material may or may not include an olefinically unsaturated structure that is capable of being polymerized per se or copolymerized with at least one of the free radical polymerizable monomers described above. The polymeric material can be for example, various solid and liquid elastomeric polymeric materials, and in particular liquid olefinic-terminated elastomers as described in U.S. Pat. Nos. 4,223,115; 4,452,944; 4,769,419; 5,641,834 and 5,710,235; and olefinic urethane reaction products of an isocyanate-functional prepolymer and a hydroxy functional monomer, as described in U.S. Pat. Nos. 4,223,115; 4,452,944; 4,467,071 and 4,769,419, the entire disclosure of each which is hereby incorporated by reference.

In another embodiment of the present invention the acrylic adhesive further comprises an adhesion promoter. An adhesion promoter in accordance with an embodiment of the present invention comprises any adhesion promoter known to those of ordinary skill in the art as useful in promoting adhesion in acrylic adhesives. Preferred adhesion promoters in accordance with an embodiment of the present invention are phosphorus-containing compounds that enhance metal adhesion and may be any derivative of phosphinic acid, phosphonic acid or phosphoric acid having at least one P—OH group and at least one organic moiety characterized by the presence of an olefinic group, which is preferably terminally located. A listing of such phosphorus compounds is found in U.S. Pat. No. 4,223,115.

In a further embodiment of the present invention, the acrylic adhesive composition optionally comprises an epoxy component. In one embodiment of the present invention, the epoxy component comprises a hardenable, epoxy functional compound (liquid resin) that contains statistically more than one oxirane ring per molecule (polyepoxide). The preferred epoxy-functional material contains two epoxy groups per molecule. A mono-functional epoxy compound can also be combined with the polyepoxide component as a viscosity modifier that acts as a reactive diluent. Epoxy resins suitable for use herein include polyglycidyl ethers of polyhydric alcohols, and polyglycidyl esters of polycarboxylic acids. Polyglycidal esters can be obtained by reacting an epihalohydrin, such as epichlorohydrin or epibromohydrin, with a aliphatic or aromatic polycarboxylic acid such as oxalic acid, succinic acid, glutaric acid, terephthalic acid, 2,6-naphthalene dicarboxylic acid, and dimerized linoleic acid. The polyglycidal ethers of aromatic polyols are preferred and are prepared by reacting epihalohydrin with a polyhydroxy phenol compound in the presence of an alkali. Suitable starting polyhydroxy phenols include resorcinol, catechol, hydroquinone, bis(4-hydroxyphenyl)-2,2-propane also known as bisphenol A, bis(4-hydroxyphenyl)-1,1-isobutane, 4,4-dihydroxybenzophenone, bis(4-hydroxyphenol)-1,1-ethane, bis(2-hydroxyphenyl)-methane, and 1,5-hydroxynaphthalene, and the diglycidyl ether of bisphenol A.

### Polyurethane

In a further embodiment of the present invention, the substrate-adhesive comprises a polyurethane-based adhesive. The polyurethane adhesive of the present invention is based on a polyurethane prepolymer prepared from certain polyhydroxy compounds and an isocyanate compound, preferably a multifunctional isocyanate, which can be utilized to create adhesive bonds.

Suitable multifunctional isocyanates include aliphatic, cycloaliphatic, and/or aromatic polyisocyanates containing at least two isocyanate groups per molecule. Owing to their good resistance to UV light, aliphatic diisocyanates yield products of low tendency to yellowing, but are more costly compared to aromatic polyisocyanates. The isocyanate component in the first part can essentially be any aliphatic or aromatic, cyclic or linear, organic isocyanate compound having an isocyanate functionality from two to four, preferably from two to three. The polyisocyanate component needed in the adhesive mixture can also contain a proportion of polyisocyanates of functionality greater than 2. Triisocyanates can be obtained by trimerization or oligomerization of diisocyanates or by reaction of diisocyanates with polyfunctional compounds containing OH or NH groups.

The isocyanates can be of low, high, or intermediate molecular weight and can be any of a wide variety of organic polyisocyanates. Typical aliphatic isocyanate compounds useful herein include hexamethylene diisocyanate, e.g. 2,2,4-trimethylhexamethylene-1,6-diisocyanate, and hexamethylene-1,6-diisocyanate (including dimers and trimers thereof), ethylene diisocyanate, trimethylene diisocyanate, dodecamethylene diisocyanate, hexamethylene diisocyanate, tetraethylene diisocyanate, pentamethylene diisocyanate, propylene-1,2-diisocyanate, 2,3-dimethyltetramethylene diisocyanate, butylene-1,3-diisocyanate, butylene-1,3-diisocyanate, 1,4-diisocyanato cyclohexane, ethylethylene diisocyanate and trimethylhexane diisocyanate, and the like. Polyisocyanates having an isocyanate functionality of at least two are disclosed in U.S. Pat. Nos. 3,350,362 and 3,382,215. Polyisocyanates which are polymeric in nature including isocyanate prepolymers of all types are included in this invention.

Cycloaliphatic polyisocyanates include cyclobutane diisocyanate, cyclopentylene diisocyanate, e.g., cyclopentene-1,3-diisocyanate, cyclohexylene diisocyanate, e.g. methylcyclohexylene diisocyanate, dicyclohexylmethane diisocyanate, e.g. bis(4-isocyanatocyclohexyl)methane, and 1,4-cyclohexane diisocyanate, e.g. 1,4-bis(isocyanatomethyl)cyclohexane.

Examples of aromatic polyisocyanates which can be used are phenylene diisocyanate, toluene diisocyanate, xylylene diisocyanate, isomers of bisphenylene diisocyanate, isomers of naphthylene diisocyanate, isomers of diphenylmethane diisocyanate, p-phenylene diisocyanate, 1-methyl phenylene-2,4-diisocyanate, naphthalene-1,4-diisocyanate, toluene diisocyanate, diphenyl-4,4′-diisocyanate, benzene-1,2,4-triisocyanate, xylene-1,4-diisocyanate, xylene-1,3-diisocyanate, 4,4′-diphenylene methane diisocyanate, 4,4′-diphenylene propane diisocyanate, and polymethylene polyphenyl isocyanate.

The polyhydroxy compounds in the second part are used for reacting with the isocyanate compound in the first part, and are mixtures primarily comprising predominantly short and long chain secondary polyols. Optionally, no more than about 25 weight percent of the polyol mixture can consist of primary polyols. More preferably no more than 15% by weight of the polyol mixture contains primary polyols, and, the most preferred limit of primary polyols present is at most about 5% by weight on total polyol weight by weight of total polyols.

The term “long chain” refers to a polyol having a molecular weight of from 2000 to 12000. Long chain polyols include the broad classes of polyether, polyester, polycaprolactone, polycarbonates, acrylic polyols, and polybutadiene types, and the like. The functionality of the long chain secondary polyol is not critical. The functionality of long chain secondary polyols can range from 1.6 to about 4. The long chain polyol used herein are predominantly secondary polyols, preferentially polyether polyols capped or terminated with a secondary hydroxyl group through addition of, for example, propylene oxide, and most preferably containing solely polyoxypropylene groups. A weight amount no more than 25% of primary hydroxy groups can be included such as polyols terminated with ethylene oxide in the amount from 1 to 25 weight percent. Preferably the amount of primary polyol is no more than 15%, and more preferably no more than 5%.

Optionally, up to about 2.0% by weight of a catalyst may be used in the polyurethane-based adhesive. The preferred catalysts are referred to as delayed-action catalysts. These include those catalysts known to facilitate a chain propagating and crosslinking reaction in the adhesive, such as between amines and isocyanates, and/or between polyols and isocyanates. The catalyst compounds, known in the art, include tin catalysts, such as dialkyl tin mercaptides, dialkyltin mercaptoacetates, and dialkyltin dimercaptoacids, including mixtures. Specific exemplary tin catalysts include dibutyltin dilaurate, dibutyltin diacetate, tin (II) acetate, tin (II) octanoate, tin (II) ethylhexanoate, tin (II) laurate, diethyltin diacetate, dibutyltin diacetate, dibutyltin dilaurate, dibutyltin maleate, dihexyltin diacetate, dioctyltin diacetate, and dibutyltin diisooctyl maleate. Dialkyl tin mercaptides include dimethyltin dimercaptide, and dibutyltin dimercaptide, and dioctyltin dimercaptide. Dialkyltin mercaptoacetates include dibutyltin diisooctyl mercapto acetate, and mixtures. Also suitable are ferric acetonate, nickel acetylacetonate. Tin catalyst can be used at 0.001 to 0.5% by weight. Tin catalysts are commercially available from Air Products and Chemical, Inc.

As is known in the art, various conventional additives are optionally included in the polyurethane-based adhesive, such as fillers, extenders, plasticizers, rheology modifiers, pigments, glass spheres, inhibitors, antioxidants, and the like. Typical fillers include silicates, talc and clay, calcium carbonate, alumina, silica, molecular sieves, and the like; inorganic and/or organic pigments include TiO2, etc.; typical plasticizers include phthalates, adipates, azelates, and the like; and typical antioxidants include hindered polyphenols such as the antioxidants sold under the tradenames IRGANOX and AOX by Ciba Specialty Chemicals. Exemplary commercial UV stabilizers are available from Ciba Specialty Chemicals under the tradename TINUVIN.

### Elastomer-Primer

In a further embodiment of the present invention, the elastomer-primer comprises a halogenated polyolefin based primer. The halogenated polyolefin comprises any natural or synthetic halogenated polyolefin elastomer. The halogens employed in the halogenated polyolefinic elastomer are typically chlorine or bromine, although fluorine can also be used. Mixtures of halogens can also be employed in which case the halogen-containing polyolefinic elastomer will have more than one type of halogen substituted thereon. The amount of halogen does not appear critical and can range from as low as about 3 weight percent to more than 70 weight percent, depending on the nature of the base elastomer or polymer. Halogenated polyolefins and their preparation are well-known to those skilled in the art.

Representative halogenated polyolefins include chlorinated natural rubber, chlorine- and bromine-containing synthetic rubbers including polychloroprene, chlorinated polychloroprene, chlorinated polybutadiene, hexachloropentadiene, butadiene/halogenated cyclic conjugated diene adducts, chlorinated butadiene styrene copolymers, chlorinated ethylene propylene copolymers and ethylene/propylene/non-conjugated diene terpolymers, chlorinated polyethylene, chlorosulfonated polyethylene, brominated poly(2,3-dichloro-1,3-butadiene), copolymers of α-haloacrylo-nitriles and 2,3-dichloro-1,3-butadiene, chlorinated poly(vinyl chloride), as discussed above, and the like, including mixtures of such halogen-containing elastomers. Thus substantially any of the known halogen-containing derivatives of natural and synthetic elastomers can be employed in the practice of this invention, including mixtures of such elastomers.

In a further embodiment of the present invention, the elastomer-primer composition preferably comprises a nitroso compound. The nitroso compound may be a nitroso compound per se, or a nitroso compound precursor. The nitroso compound useful as a crosslinker of the present invention can be any aromatic hydrocarbon, such as benzenes, naphthalenes, anthracenes, biphenyls, and the like, containing at least two nitroso groups attached directly to non-adjacent ring carbon atoms. More particularly, such nitroso compounds are described as aromatic compounds having from 1 to 3 aromatic nuclei, including fused aromatic nuclei, having from 2 to 6 nitroso groups attached directly to non-adjacent nuclear carbon atoms. The present preferred nitroso compounds are the dinitroso aromatic compounds, especially the dinitrosobenzenes and dinitrosonaphthalenes, such as the meta- or para-dinitrosobenzenes and the meta- or para-dinitrosonaphthalenes. The nuclear hydrogen atoms of the aromatic nucleus can be replaced by alkyl, alkoxy, cycloalkyl, aryl, aralkyl, alkaryl, arylamine, arylnitroso, amino, halogen, and like groups. The presence of such substituents on the aromatic nuclei has little effect on the activity of the nitroso compounds in the present invention. As far as is presently known, there is no limitation as to the character of the substituent, and such substituents can be organic or inorganic in nature. Thus, where reference is made herein to nitroso compound, it will be understood to include both substituted and unsubstituted nitroso compounds, unless otherwise specified.

Particularly preferred nitroso compounds are characterized by the formula:

(R)m-Ar—(NO)₂

wherein Ar is selected from the group consisting of phenylene and naphthalene; R is a monovalent organic radical selected from the group consisting of alkyl, cycloalkyl, aryl, aralkyl, alkaryl, arylamine, and alkoxy radicals having from 1 to 20 carbon atoms, amino, or halogen, and is preferably an alkyl group having from 1 to 8 carbon atoms; and m is zero, 1, 2, 3, or 4, and preferably is zero.

A partial non-limiting listing of nitroso compounds that are suitable for use in the practice of the invention include m-dinitrosobenzene, p-dinitrosobenzene, m-dinitrosonaphthalene, p-dinitrosonaphthalene, 2,5-dinitroso-p-cymeme, 2-methyl-1,4-dinitrosobenzene, 2-methyl-5-chloro-1,4-dinitrosobenzene, 2-fluoro-1,4-dinitrosobenzene, 2-methoxy-1-3-dinitrosobenzene, 5-chloro-1,3-dinitrosobenzene, 2-benzyl-1,4-dinitrosobenzene, 2-cyclohexyl-1,4-dinitrosobenzene and combinations thereof. Particularly preferred nitroso compounds include p-dinitrosobenzene and m-dinitroso-benzene.

The nitroso compound precursor that can function as a nitroso compound crosslinker for purposes of the present invention may be essentially any compound that is capable of being converted, typically by oxidation, to a nitroso compound at elevated temperatures, typically in the range from about 120° C. to 200° C. The most common nitroso compound precursors are derivatives of quinone compounds. Examples of quinone compound derivatives useful as nitroso compound precursors in the present invention include quinone dioxime, dibenzoquinone dioxime, 1,2,4,5-tetrachlorobenzoquinone, 2-methyl-1,4-benzoquinone dioxime, 1,4-naphthoquinone dioxime, 1,2-naphthoquinone dioxime, and 2,6-naphthoquinone dioxime.

In an additional embodiment of the present invention, the elastomer-primer compositions optionally comprise an acid-scavenging compound for purposes of consuming any acid compound by-products produced during the bonding process. The acid-scavenging compound is preferably a metal oxide or a lead-containing compound. The metal oxide of the present invention can be any known metal oxide such as the oxides of zinc, cadmium, magnesium, lead, and zirconium; litharge; red lead; zirconium salts; and combinations thereof. Various lead-containing compounds may also be utilized as an acid-scavenging compound in lieu of, or in addition to, the metal oxide. Examples of such lead-containing compounds include lead salts such as polybasic lead salts of phosphorous acid and saturated and unsaturated organic dicarboxylic acids and acid anhydrides. Specific examples of lead salts include dibasic lead phthalate, monohydrous tribasic lead maleate, tetrabasic lead fumarate, dibasic lead phosphite, and combinations thereof. Other examples of lead-containing compounds include basic lead carbonate, lead oxide and lead dioxide. For environmental reasons, metal oxides are preferred over lead-containing compounds for purposes of the invention.

In a further embodiment of the present invention, the elastomer-primer composition of the present invention may also contain a maleimide compound crosslinker. The maleimide compound crosslinker can essentially be any compound containing at least two maleimide groups. The maleimide groups may be attached to one another or may be joined to and separated by an intervening divalent radical such as alkylene, cyclo-alkylene, epoxydimethylene, phenylene (all 3 isomers), 2,6-dimethylene-4-alkylphenol, or sulfonyl. An example of a maleimide compound wherein the maleimide groups are attached to a phenylene radical is m-phenylene bismaleimide and is available as HVA-2 from E. I. Du Pont de Nemours & Co.

In further embodiments of the present invention, both the substrate-adhesive and elastomer-primer compositions of the present invention may optionally contain other well-known additives including plasticizers, fillers, pigments, surfactants, dispersing agents, wetting agents, reinforcing agents and the like, in amounts employed by those skilled in the adhesive arts to obtain a desired color and consistency. Examples of optional ingredients include carbon black, silica such as fumed silica, sodium aluminosilicate, and titanium dioxide.

### Examples

In the following Examples, the elastomer-primer was prepared in accordance with U.S. Pat. No. 5,268,404, comprising chlorosulfonated polyethylene, chlorinated natural rubber, dinitrosobenzene, an organic solvent or water, and optionally one or more of an acid scavenger, a polybismaleimide compound, a chlorinated paraffin, an epoxy novolac, selenium, and carbon black. These are designated EP-1 through EP 7 in the examples. The substrate-adhesive A is an amine-cured epoxy adhesive having an EEW/AHEW ratio (Epoxy Equivalent Weight to Amine Hydrogen Equivalent Weight) of between 0.8 to 1.2.

The bonded coupons were then subject to pull tests as outlined in standard rubber bonding test method ASTM D 429. The terminology of the results as reported include R=indicates failure of the rubber; RC=indicates failure at the rubber/rubber-primer interface; CP=indicates failure at the rubber-primer/substrate-adhesive interface; M=indicates failure at the substrate/substrate-adhesive interface. Mixed results will indicate the surface area percentage of failure as split between tow failure modes, for example 50% R, 50% RC indicates a failure mode where 50% of the rubber remains on the coupon, and 50% of the coupon is free of rubber, yet the substrate-adhesive remains on the coupon. Robust bonding will result in a test result of 100% R or nearly 100% R.

### Experiment 1—Evaluation of PV Bonding Using EP-1 and Epoxy SA-A

EP-1 was applied using a brush to the center portion of a 1″×5″×¼″ vulcanized rubber coupon that had first been wiped with isopropyl alcohol (IPA) to remove any loose surface contaminants. The EP-1 was allowed to dry at room temperature for a little over 2 hours. E-coated steel coupons (1″×5″) were masked off to expose a central area of 1″×1“. SA-A was dispensed on this central region of the steel coupon then placed on the prepared rubber coupon, using 0.030” stainless steel shims to control the bond line thickness. The mated samples were placed in a heated press and heated from the top only with the temperature set at ≤300° F. Shims were used in the press to help control the plate gap. Cure time was ≤5 minutes.

The samples were then placed in a 120° C. oven to condition them for the 120° C. pull test. Samples were allowed to equilibrate at that temperature for about 30 minutes. Immediately after removing the samples from the oven, the rubber was pulled from the heated coupon at a pull angle of between 90° and 180°.

### Cure Time Study:

| Cure Time | Failure at 120° C. |
|---|---|
| 4 min | 100% R |
| 3 min | 100% R |
| 2 min | 100% R |

It was noted that some of the SA-A adhesive squeezed out of the bond line and was incompletely cured at 4 min and uncured at 3 and 2 min.
Higher pull temp study (standard coupon prep, 5 min cure time)

| Pull Temp | Failure Mode |
|---|---|
| 120° C. | 100% R |
| 130° C. | 90% R, 10% E-C |
| 140° C. | 20% R, 80% E-C |
| 150° C. | 20% R, 80% E-C |

### Experiment 2—Evaluation of EP-2, EP-3, and EP4 in PV RTM Bonding with SA-A

Samples were prepared as described previously and bonded using a cure time of 5 minutes at 300° F., with the elastomer-primer applied to the rubber and SA-A applied on the e-coated steel. Samples were then heated to 120° C. for testing.

| Elastomer-Primer Used | Failure Mode |
|---|---|
| EP-2 | 100% R |
| EP-3 | 100% R |
| EP-4 | 100% R |

### Experiment 3—Evaluation of 250° F. Cure Temp for PV RTM Bonding

Samples were prepared as described previously with SA-A applied on e-coated steel coupons, bonded at 250° F. for 5 minutes, then pull tested at room temperature at 120° C.

| Elastomer-Primer Used | RT Failure Mode | 120° C. Failure Mode |
|---|---|---|
| EP-5 | 5% R, 95% RC | 100% R |
| EP-6 | 70% R, 30% RC* | 100% R |
| EP-1 | 5% R, 95% RC | 100% R |
| EP-7 | 5% R, 95% RC | 100% R |
| EP-2 | 100% RC | 20% R, 80% RC |
| EP-3 | 100% RC | 100% R |

*This sample had a longer cure time (approx 8 min)

### Experiment 4—Evaluation of EP-6 in PV Bonding with SA-A

Samples were prepared as described previously using EP-6 as the elastomer-primer and SA-A as the substrate-adhesive. Samples were cured at the temperature noted below, and then pull tested at room temperature.

| Set Temp. | Max Temp Reading | Total | |
|---|---|---|---|
| (° F.) | (° F.) | Cure Time | Failure Mode |
| 300 | 295 | 5 min | 50% SA-A cohesive |
| | | | 50% E-Coat failure |
| 290 | 286 | 5 min | 80% R, 20% RC |
| 280 | 271 | 5 min | 90% R, 10% RC |
| 270 | 259 | 5 min | 95% R, 5% RC |
| 260 | 248 | 5 min | 70% R, 30% RC* |

*Pull strength was lower

### Experiment 5—Evaluation of SA-A Film Thickness in PV Bonding

Samples were prepared as described previously with SA-A as the substrate-adhesive, and EP-1 as the elastomer-primer. Target dry film thickness of the EP-1 was 1-2 mils. Mated coupons were heated in a platen press heated from the steel side only at 300° F. with a cure time of 5 minutes. Pressure was applied at various levels in an attempt to reduce the SA-A bond line thickness. Samples were allowed to dry at room temperate, and then pulled at a 90° angle. The steel coupon was then cut in cross section and adhesive film thickness was measured using a digital microscope at 200× magnification.

| Sample Description | Failure Mode | SA-A Thickness | |
|---|---|---|---|
| SMC spacers used in press, | 100% R | 330 μm | (~13 mils) |
| but no metal shims | | | |
| No spacers or shims, “0 lbs | 100% R | 95 μm | (~4 mils) |
| force” setting applied. | | | |
| No spacers or shims, “50 lbs | 100% R | 50 μm | (2 mils) |
| force” setting applied | | | |
| No spacers or shims, “100 lbs | 100% R | ~40 μm | (~2 mils)* |
| force” setting applied | | | |

*It was difficult to discern SA-A layer
Note:
The EP-1 layer was ~2 mils thick in all cases.

### Experiment 6—Use of Polyurethane Chemistry as Substrate Adhesive in PV Bonding

Samples were prepared as described previously, with the epoxy-based SA-A being replaced with two urethane-based adhesives, SA-B and SA-C, and tested as described below. The polyurethane adhesives were allowed to cure at room temperature (RT—20° C.+/−5° C.) to varying degrees, in the mated assemblies prior to a 300° F. heat cure.

| Adhesive | RT Cure Time | Pull Temperature | Failure Mode |
|---|---|---|---|
| SA-B | 0 min | RT | 100% R |
| | 45 min | RT | 100% R |
| | 16 hours | RT | 100% R |
| | 3 Hours | 120° C. | 10% R, 40% TR, |
| | | | 40% C-R, 10% Coh |
| | | | urethane |
| SA-C | 0 | RT | 30% R, 70% TR |
| | 45 min | RT | 100% R |
| | 16 hours | RT | 100% R |

### Experiment 7—Bonding Rubber to Carbon Fiber Composite Substrate

The shiny smooth side of a composite coupon was scuff/sanded and then masked off in a 1″×1″ area. Vulcanized rubber coupons were wiped with IPA, and a thin layer (1-2 mils DFT) of EP-1 was applied and allowed to try at room temperature. SA-A was applied to the masked area of the composite coupon, and then mated to the rubber with 0.030″ steel shims used to control bond line thickness. One coupon was immediately cured at ≤300° F. for 8 minutes. The other coupon was allowed to cure at room temperature for >24 hours, then heated to ≤300° F. for 8 minutes. After cooling to room temp, the rubber was pulled. Both coupons yielded 100% R tear failure, displaying excellent adhesion between the rubber and composite substrates.

### Experiment 8—Environmental Testing

Environmental resistance of a bonded coupon was tested in conjunction with three different rubber samples including Rubber A and Rubber B (commercially available natural rubber formulations) as well as HC-130 (an in-house natural rubber formulation). Zinc phosphatized steel coupons were employed as the substrate and the rubber was prepped with a xylene wipe before the indicated rubber primer was applied at a DFT of 1.5 mils. SA-A adhesive was applied, and the assemblies were cured for 5 minutes once the bond line reached 300° F.

The bonded coupons were tested for Primary Adhesion, 7 day hanging salt spray, 4 hour stressed boiling water, 15 minute oven soak at 250° F. pull hot, 1 week at 0° F., 1 week immersed in Plurasafe 800 stressed at 200° F., and 1 week immersed in ASTM Oil #3 stressed at 200° F. Results are presented below:

| | Primary | | | | Hot Tear | | | |
|---|---|---|---|---|---|---|---|---|
| | Adhesion | Failure | Salt Spray | Boiling Water | Failure | 0 deg F. | Plurasafe 800 | ASTM Oil #3 |
| Primers | # pull | Mode | Failure Mode | Failure Mode | Mode | Failure Mode | Failure Mode | Failure Mode |
| RUBBER A | | | | | | | | |
| EP-4 | 74 | 100R | 60R, RC | 100R | 100R | 100R | 100R | 100R |
| | 84 | 100R | 50R, RC | 100R | 100R | 100R | 100R | 100R |
| | 86 | 100R | 50R, RC | 100R | 100R | 100R | 100R | 100R |
| EP-6 | 106 | 100R | 100R | 100R | 100R | 100R | 100R | 100R |
| | 91 | 100R | 100R | 100R | 100R | 100R | 100R | 100R |
| | 84 | 100R | 100R | 100R | 100R | 100R | 100R | 100R |
| RUBBER B | | | | | | | | |
| EP-4 | 91 | 100R | 100RC | 100R | 100R | 100R | 100R | 100R |
| | 97 | 100R | 100RC | 100R | 100R | 100R | 100R | 100R |
| | 89 | 100R | 100RC | 100R | 100R | 100R | 100R | 100R |
| EP-6 | 77 | 100R | 100R | 100R | 100R | 100R | 100R | 100R |
| | 77 | 100R | 100R | 100R | 100R | 100R | 100R | 100R |
| | 74 | 100R | 100R | 100R | 100R | 100R | 100R | 100R |
| HC130 | | | | | | | | |
| EP-4 | 72 | 100R | 80R, RC | 100R | 100R | 100R | 100R | 100R |
| | 64 | 100R | 75R, RC | 100R | 100R | 100R | 100R | 100R |
| | 72 | 100R | 75R, RC | 100R | 100R | 100R | 100R | 100R |
| EP-6 | 88 | 100R | 80R, RC | 100R | 100R | 100R | 100R | 100R |
| | 95 | 100R | 100R | 100R | 100R | 100R | 100R | 100R |
| | 90 | 100R | 90R, RC | 100R | 100R | 100R | 100R | 100R |

What is claimed is:

1-17. (canceled)

18. A method for post vulcanization bonding of an elastomer comprising
(a) providing a vulcanized elastomer;
(b) applying an elastomer-primer composition to the vulcanized elastomer wherein the elastomer-primer composition comprises a halogenated polyolefin and dinitrosobenezene;
(c) providing a substrate to be bonded;
(d) applying a substrate-adhesive to the substrate wherein the substrate-adhesive comprises at least one of an epoxy, acrylic, or urethane based adhesive;
(e) bringing the elastomer-primer coated vulcanized elastomer into contact with the substrate-adhesive coated substrate such that at least a portion of the substrate adhesive contact at least a portion of the elastomer-primer to form an assembly.

19. The method of claim 18, further comprising the step of (f) heating the assembly to cure the elastomer-primer.

20. The method of claim 19, wherein the assembly is heated to at least 250° F. for at about 5 minutes.

21. The method of claim 18, wherein the elastomer-primer is applied to the elastomer without a pre-treatment step.

22. The method of claim 18, wherein halogenated polyolefin comprises brominated poly(dichlorobutadiene).

23. The method of claim 18, wherein the halogenated polyolefin comprises chlorinated natural rubber.

24. The method of claim 18, wherein the halogenated polyolefin comprises chlorosulfonated polyethylene.

25. The method of claim 18, wherein the nitroso compound comprises poly-dinitrosobenzene.

26. The method of claim 18, wherein the substrate-adhesive comprises a urethane based adhesive and further includes a catalyst.

27. The method of claim 18, wherein the substrate-adhesive comprises an epoxy based adhesive and further comprises an amine hardener.

28. The method of claim 18, wherein the substrate-adhesive comprises an acrylic based adhesive further comprising redox initiator system.

29. The method of claim 18, wherein the substrate-adhesive is essentially free, or free, of phenolic resins, other than phenolic epoxy materials.

30. The method of claim 18, wherein the substrate-adhesive is essentially free, or free, of halogenated polyolefins.

31. The method of claim 18, wherein the elastomer-primer is essentially free, or free, of epoxy resins, other than phenolic epoxy materials.

32. The method of claim 18, wherein the elastomer-primer is essentially free, or free, of phenolic resins.

33. The method of claim 18, wherein the elastomer-primer comprises a bismaleimide material.

34. The method of claim 18, wherein the elastomer-primer comprises a solvent-based primer.

35. The method of claim 18, wherein the elastomer-primer comprises an aqueous primer.

36. The method of claim 18, wherein the assembly exhibits at least 90% rubber retention when pulled at a temperature of above 100° C. at an angle of 90° in accordance with ASTM D 429.
